(19) United States
(12) Patent Application Publication
(10) Pub. No.: US 2015/0341938 A1
(43) Pub. Date: Nov. 26, 2015

(54) UPLINK OPERATION FOR RLC COMMUNICATIONS

(71) Applicant: QUALCOMM Incorporated, San Diego, CA (US)

(72) Inventors: Mohammed Tawashi, San Diego, CA (US); Siva Kumar Jujaray, San Diego, CA (US); Mouaffac Ambriss, San Diego, CA (US); Amir Aminzadeh Gohari, Poway, CA (US); Masato Kitazoe, Hachiouji-shi (JP); Aziz Gholmieh, San Diego, CA (US); Gang Andy Xiao, San Diego, CA (US); Madhusudan Kinthada Venkata, San Diego, CA (US); Srinivasan Balasubramanian, San Diego, CA (US)

(73) Assignee: QUALCOMM Incorporated, San Diego, CA (US)

(21) Appl. No.: 14/285,294

(22) Filed: May 22, 2014

(51) Int. Cl. H04W 72/04

(52) U.S. Cl. CPC H04W 72/0486

(57) ABSTRACT

A user equipment (UE) may have data in a buffer for uplink (UL) transmission. The UE may transmit a buffer status report (BSR) indicating the amount of data. The BSR may fail or a base station may not grant sufficient resources for transmission of the data. A BSR failure condition may be based on a radio link control (RLC) operating mode of the data. For example, the data may be an acknowledgement (ACK) for an acknowledged mode (AM) DL transmission. In this case, the UE may initiate a BSR retransmission (Retx-BSR) timer and determine whether any duplicate transmissions have been received. The data may also be associated with an unacknowledged mode (UM), and the BSR failure condition may include waiting for a time interval that is less than the Retx-BSR time interval. When the BSR failure condition is satisfied, the UE may transmit a scheduling request to the base station.

### BACKGROUND

Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code division multiple access (CDMA) systems, time division multiple access (TDMA) systems, frequency division multiple access (FDMA) systems, and orthogonal frequency division multiple access (OFDMA) systems, e.g., a Long Term Evolution (LTE) system.

Generally, a wireless multiple-access communications system may include a number of base stations, each simultaneously supporting communication for multiple mobile devices or other user equipment (UE) devices. Base stations may communicate with UEs on downstream and upstream links. Each base station has a coverage range, which may be referred to as the coverage area of the cell. A UE may both receive data from a base station (downlink) and transmit data to a base station (uplink). The UE may hold uplink (UL) transmissions in a buffer until it has received a resource grant from the base station. The UE may send a buffer status report (BSR) to the base station indicating that data is being held for transmission. In some cases the BSR may fail and/or the base station may not grant sufficient resources for the data. Failure to receive a timely grant in response to the BSR may lead to a poor user experience and/or reduced network efficiency.

### SUMMARY

The described features generally relate to one or more improved systems, methods, and/or apparatuses for improved uplink operation for radio link control (RLC) communications. A UE may have data in a buffer for UL transmission. The UE may transmit a BSR indicating the amount of the data. The BSR may fail or a base station may not grant sufficient resources for transmission of the data. The UE may detect a BSR failure condition based on an RLC operating mode of the data. For example, the data may be an ACK for an acknowledged mode (AM) DL transmission. In this case, the UE may initiate a Retx-BSR timer and determine whether any duplicate DL RLC transmissions have been received. In another example, the data may be associated with an unacknowledged mode (UM), and the BSR failure condition may include waiting for a time interval that is less than the Retx-BSR time interval. When the BSR failure condition is satisfied, the UE may transmit a scheduling request to the base station even before the Retx-BSR timer expiry.

A method of improved uplink operation for RLC communications is described, the method comprising determining the availability of data for UL transmission, transmitting a BSR indicating an amount of the data, determining that a BSR failure condition has been satisfied prior to expiration of a first time interval associated with the BSR, wherein the BSR failure condition is based at least in part on an RLC mode associated with the data and on a determination that a grant of UL resources has not been received, and performing an alternative request procedure based on the determination that the BSR failure condition has been satisfied prior to expiration of the first time interval.

An apparatus for improved uplink operation for RLC communications is described, the apparatus comprising means for determining the availability of data for UL transmission, means for transmitting a BSR indicating an amount of the data, means for determining that a BSR failure condition has been satisfied prior to expiration of a first time interval associated with the BSR, wherein the BSR failure condition is based at least in part on an RLC mode associated with the data and on a determination that a grant of UL resources has not been received, and means for performing an alternative request procedure based on the determination that the BSR failure condition has been satisfied prior to expiration of the first time interval.

An apparatus for improved uplink operation for RLC communications is also described, the apparatus comprising a processor, memory in electronic communication with the processor, and instructions stored in the memory, the instructions being executable by the processor to determine the availability of data for UL transmission, transmit a BSR indicating an amount of the data, determine that a BSR failure condition has been satisfied prior to expiration of a first time interval associated with the BSR, wherein the BSR failure condition is based at least in part on an RLC mode associated with the data and on a determination that a grant of UL resources has not been received, and perform an alternative request procedure based on the determination that the BSR failure condition has been satisfied prior to expiration of the first time interval.

A computer program product for improved uplink operation for RLC communications is also described, the computer program product comprising a non-transitory computer-readable medium storing instructions executable by a processor to determine the availability of data for UL transmission, transmit a BSR indicating an amount of the data, determine that a BSR failure condition has been satisfied prior to expiration of a first time interval associated with the BSR, wherein the BSR failure condition is based at least in part on an RLC mode associated with the data and on a determination that a grant of UL resources has not been received, and perform an alternative request procedure based on the determination that the BSR failure condition has been satisfied prior to expiration of the first time interval. Some examples comprise the data comprises an ACK for a corresponding DL transmission in an RLC AM.

Some examples of the method, apparatuses, and/or computer program product described above may further comprise determining that the BSR failure condition has been satisfied comprises initiating a retransmission timer associated with the first time interval, and receiving a duplicate DL AM protocol data unit (PDU) prior to expiration of the first time interval comprising a repetition of data received in the DL transmission. In some examples discarding the duplicate DL AM PDU.

In some examples of the method, apparatuses, and/or computer program product described above the RLC mode associated with the data is a UM. Some examples comprise determining that the BSR failure condition has been satisfied comprises initiating a retransmission timer, determining that a second time interval has expired based on the retransmission timer, wherein the second time interval is shorter than the first time interval, receiving the grant of UL resources based on the alternative request procedure, and transmitting the data.

Some examples of the method, apparatuses, and/or computer program product described above may further comprise a duration of the second time interval is based on a value of a hybrid automatic repeat request (HARD) round trip timer (RTT). In some examples the duration of the second time interval is based on a maximum HARQ transmission parameter.

In some examples of the method, apparatuses, and/or computer program product described above transmitting a scheduling request (SR) after the second time interval expires. Some examples comprise determining that the BSR failure condition has been satisfied is based a traffic type of the data.

In some examples of the method, apparatuses, and/or computer program product described above the traffic type of the data is characterized by a quality of service (QoS) class identifier (QCI) value less than a threshold. In some examples the traffic type of the data is a voice traffic type or video telecommunications traffic type.

Some examples of the method, apparatuses, and/or computer program product described above may further comprise the traffic type is based on a predictable traffic pattern. Some examples comprise determining that the BSR failure condition has been satisfied comprises receiving a predetermined number of negative acknowledgment (NACK) indications associated with the BSR.

In some examples of the method, apparatuses, and/or computer program product described above the predetermined number is based on a maximum HARQ transmission parameter. In some examples determining that the BSR failure condition has been satisfied comprises flushing a HARQ buffer prior to receiving an ACK for the BSR.

In some examples of the method, apparatuses, and/or computer program product described above determining that the BSR failure condition has been satisfied comprises determining that the UE tuned away from a network cell prior to receiving an ACK for the BSR. Some examples comprise the alternative request procedure comprises transmitting an SR.

Some examples of the method, apparatuses, and/or computer program product described above may further comprise determining that the SR has failed, and initiating a random access procedure. In some examples repeating transmission of the SR.

In some examples of the method, apparatuses, and/or computer program product described above the repeated transmission of the SR is limited to a maximum rate. In some examples the alternative request procedure comprises determining that resources have not been granted for an SR, and initiating a random access procedure.

In some examples of the method, apparatuses, and/or computer program product described above the determination that a grant of UL resources has not been received comprises a determination that UL resources have not been granted for at least a portion of the data. In some examples the first time interval is a based on a Retx-BSR timer.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an example of a wireless communications;

FIG. 2 illustrates an example of a wireless communication system for improved uplink operation for RLC AM communications;

FIG. 3 illustrates an example of a wireless communication system for improved uplink operation for RLC UM communications;

FIG. 4 shows a block diagram of a device for improved uplink operation for RLC communications in accordance with various embodiments;

FIG. 5 shows a block diagram of a device for improved uplink operation for RLC communications;

FIG. 6A shows a block diagram of a device for improved uplink operation for RLC communications;

FIG. 6B shows a block diagram of a device for improved uplink operation for RLC communications;

FIG. 7 illustrates a block diagram of a system for improved uplink operation for RLC communications;

FIG. 8 shows a flowchart illustrating a method for improved uplink operation for RLC communications;

FIG. 9 shows a flowchart illustrating a method for improved uplink operation for RLC communications in accordance with various embodiments;

FIG. 10 shows a flowchart illustrating a method for improved uplink operation for RLC communications; and

FIG. 11 shows a flowchart illustrating a method for improved uplink operation for RLC communications.

### DETAILED DESCRIPTION

The described features generally relate to one or more improved systems, methods, and/or apparatuses for improved uplink operation for RLC communications. For example, a UE may have data in a buffer for UL transmission and may hold the data in the buffer until the UE has received a resource grant from a base station. The UE may also transmit a BSR to the base station to indicate that data is being held for transmission and the amount of the data. However, in some cases the BSR may fail or the base station may not grant sufficient resources for transmission of the data. In these cases, it may be desirable to detect the BSR failure condition and to employ an alternative procedure for obtaining UL resources prior to the expiration of a Retx-BSR timer.

According to the present disclosure, a BSR failure condition may be based on an RLC operating mode of the data. For example, the data to be transmitted may be an ACK (e.g., an RLC Status Report) for an acknowledged mode (AM) DL transmission. In this case, the UE may initiate a Retx-BSR timer and monitor for duplicate RLC transmissions as an indication of BSR failure. In another example, the data to be transmitted may be associated with an unacknowledged mode (UM), and the BSR failure condition may include waiting for a time interval that is less than the Retx-BSR time interval and which may, for example, be based on network parameters such as hybrid automatic repeat request (HARQ) round trip time (RTT) and max HARQ retransmission operation. When the BSR failure condition is satisfied, the UE may transmit a scheduling request to the base station.

By monitoring for and detecting a BSR failure condition, a UE may initiate a scheduling request or an alternative procedure such as a random access procedure prior to the expiration of the Retx-BSR timer. This may prevent avoidable duplicate RLC transmissions in the RLC AM case, or prevent avoidable discarding of packets in the UM case in situations where flexibility based on the RLC mode and/or type of traffic can be advantageous. This may result in more efficient operation and/or better quality of service for the user.

The following description provides examples, and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

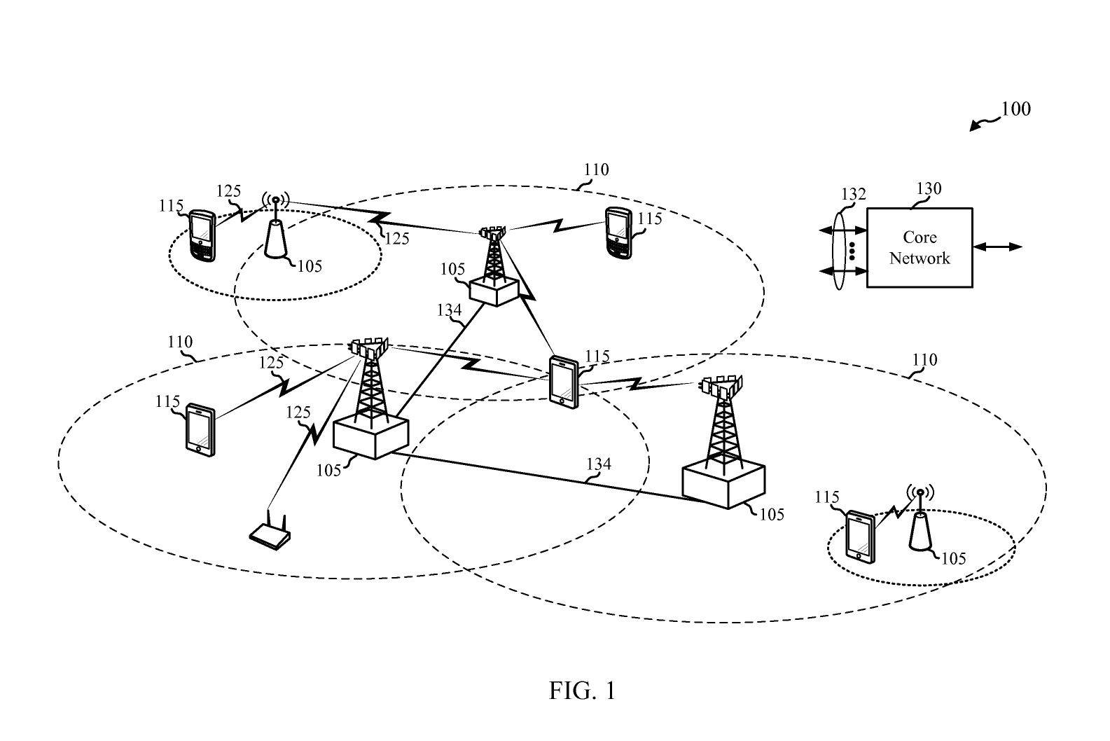

FIG. 1 illustrates an example of a wireless communications system 100 in accordance with various embodiments. The system 100 includes base stations 105, communication devices, also known as a user equipment UE 115, and a core network 130. The base stations 105 may communicate with the UEs 115 under the control of a base station controller (not shown), which may be part of the core network 130 or the base stations 105 in various embodiments. Base stations 105 may communicate control information and/or user data with the core network 130 through backhaul links 132. In embodiments, the base stations 105 may communicate, either directly or indirectly, with each other over backhaul links 134, which may be wired or wireless communication links. The system 100 may support operation on multiple carriers (waveform signals of different frequencies). Wireless communication links 125 may be modulated according to various radio technologies. Each modulated signal may carry control information (e.g., reference signals, control channels, etc.), overhead information, data, etc.

Various types of data may be sent on communication links 125, and the mode of communication may depend on the type of data being transmitted. For example, some data may be sent according to RLC AM, in which transmissions are followed by an ACK. Other traffic types may be sent according to an RLC UM, such as time-sensitive voice or video telecommunications data that may be discarded rather than retransmitted if a transmission is unsuccessful.

The base stations 105 may wirelessly communicate with the UEs 115 via one or more base station antennas. Each of the base station 105 sites may provide communication coverage for a respective geographic area 110. In some embodiments, base stations 105 may be referred to as a base transceiver station, a radio base station, an access point, a radio transceiver, a basic service set (BSS), an extended service set (ESS), a NodeB, evolved node B (eNB), Home NodeB, a Home eNodeB, or some other suitable terminology. The coverage area 110 for a base station may be divided into sectors making up only a portion of the coverage area (not shown. The system 100 may include base stations 105 of different types (e.g., macro, micro, and/or pico base stations). There may be overlapping coverage areas for different technologies.

The system 100 may be a Heterogeneous LTE/LTE-A network in which different types of base stations provide coverage for various geographical regions. For example, each base station 105 may provide communication coverage for a macro cell, a pico cell, a femto cell, and/or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell.

The core network 130 may communicate with the base stations 105 via a backhaul 132 (e.g., S1, etc.). The base stations 105 may also communicate with one another, e.g., directly or indirectly via backhaul links 134 (e.g., X2, etc.) and/or via backhaul links 132 (e.g., through core network 130). The wireless communications system 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. The techniques described herein may be used for either synchronous or asynchronous operations.

The UEs 115 may be dispersed throughout the wireless communications system 100, and each UE may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A UE may be able to communicate with macro eNBs, pico eNBs, femto eNBs, relays, and the like.

The communication links 125 shown in system 100 may include UL transmissions from a UE 115 to a base station 105, and/or DL transmissions, from a base station 105 to a UE 115 over DL carriers. The downlink transmissions may also be called forward link transmissions while the uplink transmissions may also be called reverse link transmissions.

A UE 115 may hold UL transmissions in a buffer until it has received a resource grant from a base station 105. The UE may send a BSR to the base station indicating that data is being held for transmission. In some cases the BSR may fail and/or the base station may not grant sufficient resources for the data.

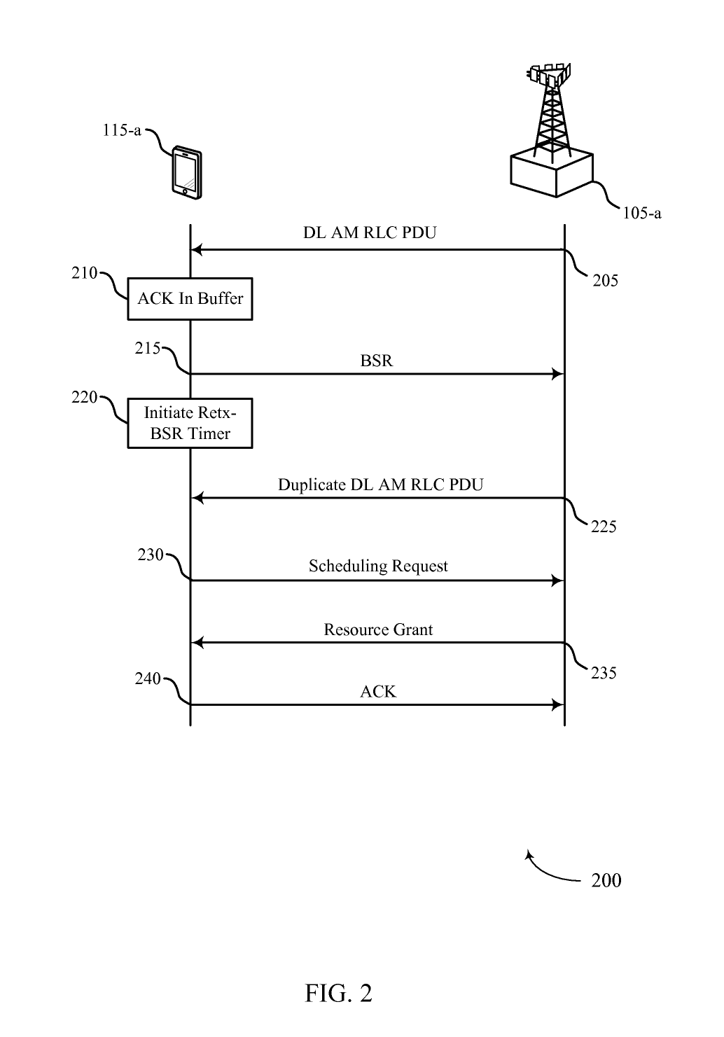

FIG. 2 illustrates an example of a wireless communication system 200 for improved uplink operation for RLC AM communications in accordance with various embodiments. System 200 may include a UE 115-a which may be an example of a UE 115, and a base station 105-a which may be an example of a base station 105 with reference to FIG. 1. The base station 105-a may send a transmission 205 (e.g., a DL AM RLC PDU) to UE 115-a. The UE 115-a may then determine the availability of data 210 for UL transmission. For example, the UE 115-a may have an ACK in buffer that corresponds to the transmission 205. The UE 115 may transmit a BSR 215 to base station 105-a indicating an amount of the data 210 which serves as a request for uplink resources on which the data, including an RLC status report acknowledging receipt of transmission 205, may be sent. The UE 115 may then determine that a BSR failure condition has been satisfied (e.g., that the BSR failed or that insufficient resources have been granted for transmission of the ACK 210).

Evaluating the BSR failure condition may include initiating a retransmission timer 220, e.g., a Retx-BSR timer. In one example, the retransmission timer 220 may be an aspect of an LTE mechanism for requesting resources if a BSR fails. As discussed herein, reliance on the Retx-BSR timer, lacks flexibility and fails to account for differences due to RLC operating mode, requirements associated with different types of traffic, etc. In one aspect, receiving a duplicate transmission 225, e.g., a duplicate DL AM PDU, prior to expiration of the retransmission timer 220 may trigger a BSR failure procedure. That is, the UE may infer from reception of the duplicate DL AM PDU 225 that the BSR 215 has failed and/or that resources may be conserved by initiating a scheduling request (SR) prior to expiration of the retransmission timer 220. In some cases, the base station 105-a may continue to send multiple duplicate transmissions because it has not received an ACK, even though the data has been successfully received. The UE 115-a may discard the duplicate PDUs.

The UE 115-a may utilize an alternative procedure when BSR failure is detected. For example, the UE may transmit an SR 230 to the base station 105-a prior to expiration of the Retx-BSR interval rather than waiting for the interval to expire or for the eNB releases the UE connection after reaching a maximum number of retransmissions. In other examples, the UE may determine that the scheduling request was not successful and initiate a random access procedure. In some cases the UE may receive a UL resource grant 235 based on the alternative scheduling procedure (e.g., the scheduling request 230). Then the UE 115-a may send the ACK 240 using the resources indicated in the resource grant 235. This may allow the UE to receive additional DL AM RLC PDUs (not shown) rather than continue to receive duplicate PDUs.

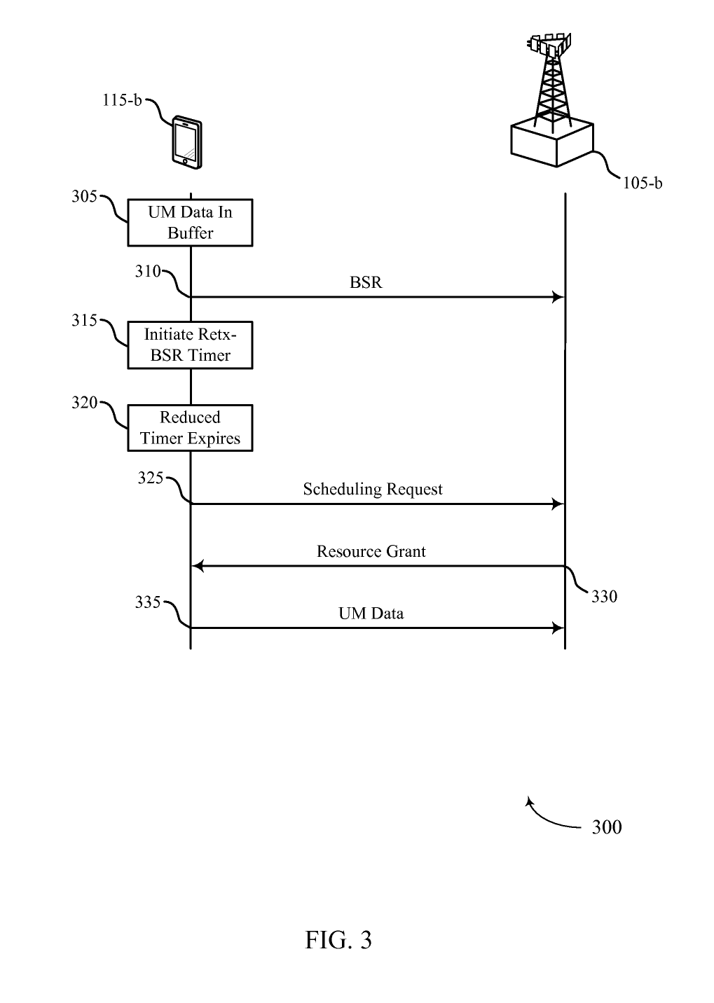

FIG. 3 illustrates an example of a wireless communication system 300 for improved uplink operation for RLC UM communications in accordance with various embodiments. System 300 may include a UE 115-b which may be an example of a UE 115, and a base station 105-b which may be an example of a base station 105 with reference to FIG. 1. UE 115-b may determine that UM data 305 is available for transmission, e.g., stored in a buffer. UE 115-b may then transmit a BSR 310 indicating the amount of data. Based on the type of the data 305, the UE 115-b may then determine that a BSR failure condition has been satisfied. Evaluating the BSR Failure condition may include initiating a retransmission timer 315, e.g., a Retx-BSR timer in an LTE network. However, based on the type of data 305 in the buffer, the UE 115-b may either initiate an additional timer or reset the retransmission timer 315 with a reduced interval. The UE 115-b may then determine that the reduced time interval has expired.

In some cases, the BSR failure condition may be based on the traffic type of the data. For example, voice or video telecommunications data may be time sensitive and may be sent in RLC UM mode. In some examples, the data packets may be discardable after a predetermined time period. In some examples the traffic type of the data may be characterized by a quality of service (QoS) class identifier (QCI) value less than a threshold value. In some examples, the traffic type may be based on a predictable traffic pattern. For example, voice data may be generated at a relatively consistent and predictable rate.

As one example, the value for the Retx-BSR timer in current LTE systems ranges from 320 ms to 10.24 s and is used with both acknowledged and unacknowledged mode transmissions. This value may be considerably larger than a voice packet generation rate (typically one frame every 20 ms) or the expected voice packet transmission rate on the UL (e.g., once every 20 or 40 ms). Thus, waiting for the Retx-BSR timer to reach its minimum value may result in a significant difference between a voice packet generation rate (with its expected voice packet transmission rate) and an actual transmission rate. This may impact audio quality as delayed voice packets can get dropped in accordance with a discard timer. That is, even if delivered to the network, the voice packets may be considered stale and not played out by the receiving device.

In one example, the reduced interval (T_{wait}) may be based on a value of a hybrid automatic repeat request (HARQ) round trip time (RTT) Timer and/or a maximum HARQ transmission parameter (maxHARQ-Tx):

T_{wait}=(HARQ RTT Timer)·(maxHARQ−Tx)+5 (1)

where maxHARQ-Tx may configured by the base station 105-b. For example, in frequency division duplexing (FDD) the HARQ RTT is 8 subframes. For time division duplexing (TDD) the HARQ RTT Timer may set to k+4 subframes, where k is the interval between the downlink transmission and the transmission of associated HARQ feedback. Of course, the present example is illustrative only and demonstrates that a reduced interval for determining BSR failure may be based, at least in part, on HARQ-related parameters of the network.

After the UE has determined that the BSR failure condition has been satisfied (e.g., the reduced interval has expired), the UE 115-b may perform an alternative request procedure. For example, the UE may transmit an SR 325. Unlike the BSR which is transmitted on the shared channel and which therefore needs a grant of UL resources, the scheduling request is transmitted on the control channel as determined by the UE in a further attempt to obtain UL resources. If the UE fails to obtain UL resources in response to the SR, it may further escalate the alternative procedure and perform a random access channel (RACH) procedure. In some cases the UE may receive an UL resource grant 330 in response to these alternative request procedures (e.g., the SR 325 or RACH attempt). Using the resources indicated in the resource grant 330, the UE 115-b may transmit the UM data 305 in transmission 335.

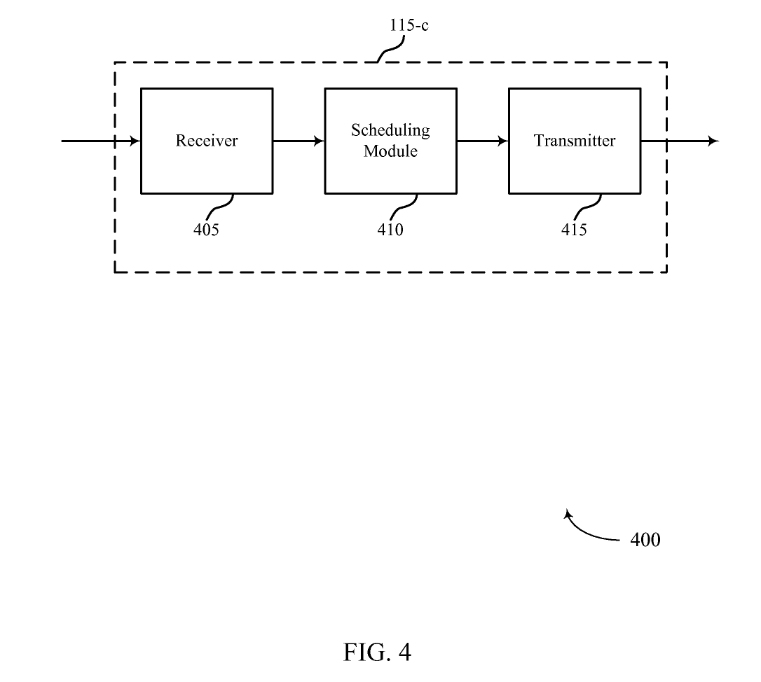

FIG. 4 shows a block diagram 400 of a UE 115-c for improved uplink operation for RLC communications. The UE 115-c may be an example of one or more aspects of a UE 115 described with reference to FIGS. 1-3. The UE 115-c may include a receiver 405, a scheduling module 410, and/or a transmitter 415. The UE 115-c may also include a processor. Each of these components may be in communication with each other.

The components of the UE 115-c may, individually or collectively, be implemented with at least one application specific integrated circuit (ASIC) adapted to perform some or all of the applicable functions in hardware. Alternatively, the functions may be performed by one or more other processing units (or cores), on at least one integrated circuit (IC). In other embodiments, other types of integrated circuits may be used (e.g., Structured/Platform ASICs, a field programmable gate array (FPGA), or another Semi-Custom IC), which may be programmed in any manner known in the art. The functions of each unit may also be implemented, in whole or in part, with instructions embodied in a memory, formatted to be executed by one or more general or application-specific processors.

The receiver 405 may receive information such as packets, user data, and/or control information associated with various information channels (e.g., control channels, data channels, etc.). Information may be passed on to the scheduling module 410, and to other components of the UE 115-c. In some examples, the receiver 405 may be configured to receive a grant of UL resources based on an alternative request procedure.

The scheduling module 410 may be configured to perform functions that improve RLC scheduling operations. Specifically, the scheduling module 410 may be configured to determine the availability of data for UL transmission. The scheduling module 410 may be configured to transmit a BSR indicating an amount of the available data in coordination with transmitter 415 and which may include an RLC status report or other acknowledgement indication. The scheduling module 410 may also be configured to determine that a BSR failure condition has been satisfied prior to expiration of a first time interval associated with the BSR, wherein the BSR failure condition is based at least in part on an RLC mode associated with the data and on a determination that a grant of UL resources has not been received. The scheduling module 410 may also be configured to perform an alternative request procedure based on the determination that the BSR failure condition has been satisfied prior to expiration of the first time interval.

The transmitter 415 may transmit the one or more signals received from other components of the UE 115. The transmitter 415 may also be configured to transmit a BSR indicating an amount of the data available to be transmitted. In some aspects, the transmitter 415 may be collocated with the receiver 405 in a transceiver module. The transmitter 415 may include a single antenna, or it may include a plurality of antennas. In some examples, the transmitter 415 may be configured to transmit the data using resources received in a grant of UL resources.

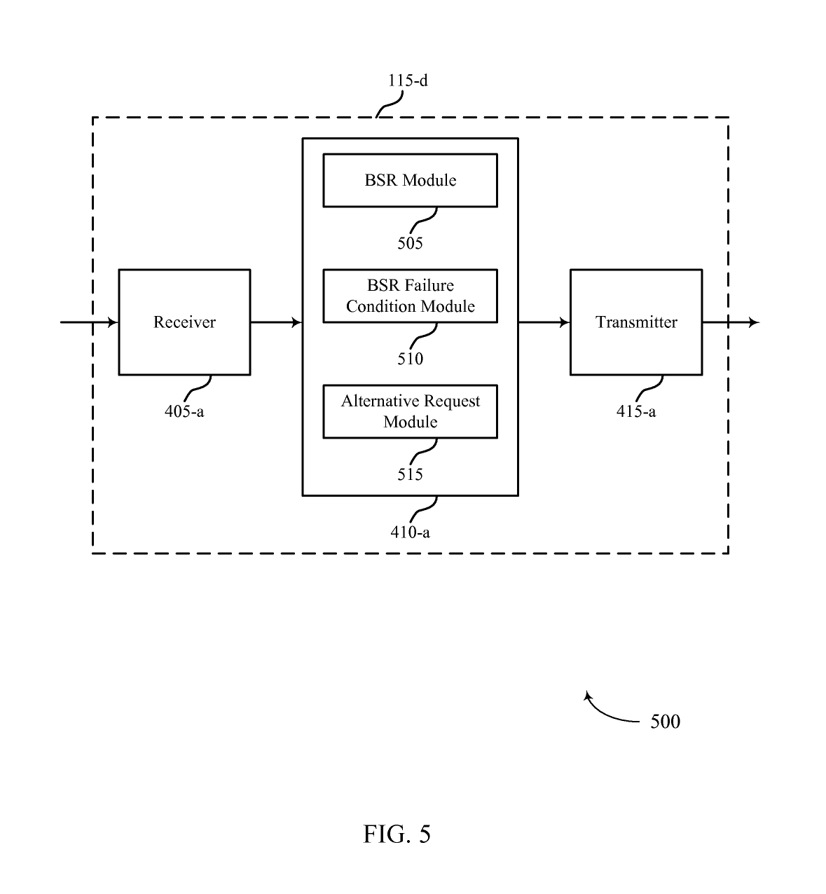

FIG. 5 shows a block diagram 500 of a UE 115-d for improved uplink operation for RLC communications in accordance with various embodiments. The UE 115-c may be an example of one or more aspects of a UE 115 described with reference to FIGS. 1-4. The UE 115-d may include a receiver 405-a, a scheduling module 410-a, and/or a transmitter 415-a. The UE 115-d may also include a processor. Each of these components may be in communication with each other. The scheduling module 410-a may also include a BSR module 505, a BSR failure condition module 510, and an alternative request module 515.

The components of the UE 115-d may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another Semi-Custom IC), which may be programmed in any manner known in the art. The functions of each unit may also be implemented, in whole or in part, with instructions embodied in a memory, formatted to be executed by one or more general or application-specific processors.

The receiver 405-a may receive information which may be passed on to the scheduling module 410-a, and to other components of the UE 115-d. The receiver 405-a may be an example of receiver 405 of FIG. 4. The scheduling module 410-a may be configured to perform the operations described above with reference to FIG. 4 and as further described below, and may be an example of scheduling module 410 of FIG. 4. The transmitter 415-a may transmit the one or more signals received from other components of the UE 115-d. The transmitter 415-a may be an example of transmitter 415 of FIG. 4.

The BSR module 505 may be configured to determine the availability of data for UL transmission. The BSR module 505 may also be configured to transmit a BSR indicating an amount of the data in coordination with transmitter 415-a and operative to request uplink resources for transmitting the available data. The available data may, for example, include and RLC status report or other acknowledgment of DL transmission in the RLC AM operation. Similarly, the BSR may indicate the need for uplink resource in connection with a time-sensitive transmission such as with VoIP or VT services. In some aspects, a BSR retransmission timer (Retx-BSR) may be started in connection with sending the BSRs.

The BSR failure condition module 510 may be configured to detect or otherwise determine that a BSR failure condition has occurred prior to expiration of a first time interval associated with the BSR. The BSR failure condition may be configured to allow the UE to obtain a resource grant from a base station 105 without waiting for expiration of the first time interval. The BSR failure condition may be based at least in part on an RLC mode associated with the data and on a determination that a grant of UL resources has not been received. The BSR failure condition module 510 may be configured such that the determination that a grant of UL resources has not been received may include a determination that UL resources have not been granted for at least a portion of the data. The BSR failure condition module 510 may be configured such that the first time interval is based on a Retx-BSR timer.

In some examples, the BSR failure condition module 510 may be configured such that determining that the BSR failure condition has been satisfied may include receiving a predetermined number of NACK indications associated with the BSR. The one or more NACK indications may enable the UE to infer that the BSR has failed. The BSR failure condition module 510 may also be configured such that determining that the BSR failure condition has been satisfied may include flushing a HARQ buffer prior to receiving an ACK for the BSR. In the case that the UE flushes the HARQ buffer, it may be an indication that a threshold time period has passed and that the BSR has likely failed. In some examples, the BSR failure condition module 510 may be configured such that determining that the BSR failure condition has been satisfied may include determining that the UE tuned away from a network cell prior to receiving an ACK for the BSR. That is, if the UE tunes away from a network cell it may not be able to confirm reception of the BSR and may determine that the BSR has failed.

The alternative request module 515 may be configured to perform an alternative request procedure or sequence of operations based on the determination that the BSR failure condition has been satisfied prior to expiration of the first time interval. For example, the alternative request module 515 may be configured to transmit an SR in coordination with transmitter 415-a. By advancing the timing of SR transmission based upon detecting the BSR failure condition, the UE may indicate to a base station that a UE has data to transmit urgently. However, whereas a BSR may be sent on a Physical Uplink Shared Channel (PUSCH) with resources received in an UL resource grant, an SR may be sent on a Physical Uplink Control Channel (PUCCH) using a PUCCH resource. PUCCH and PUSCH may utilize different scheduling procedures and/or data rates. Thus, according to the present disclosure, on aspect of the alternative request procedure is the ability to send a scheduling request on PUCCH when a grant on PUSCH is not forthcoming in response to the BSR. In another example, the alternative request module 515 may be configured to initiate a random access procedure. A random access procedure may be a means of reconnecting to a base station if the connection has been compromised. BSR failure and/or failure of one or more SR messages may be an indication that a random access procedure may be appropriate.

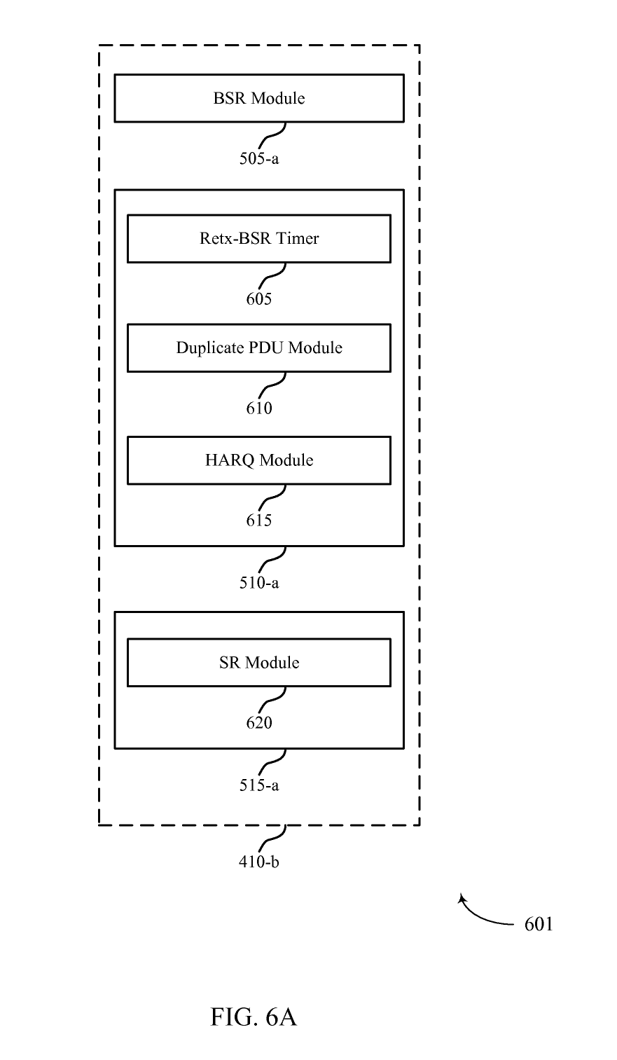

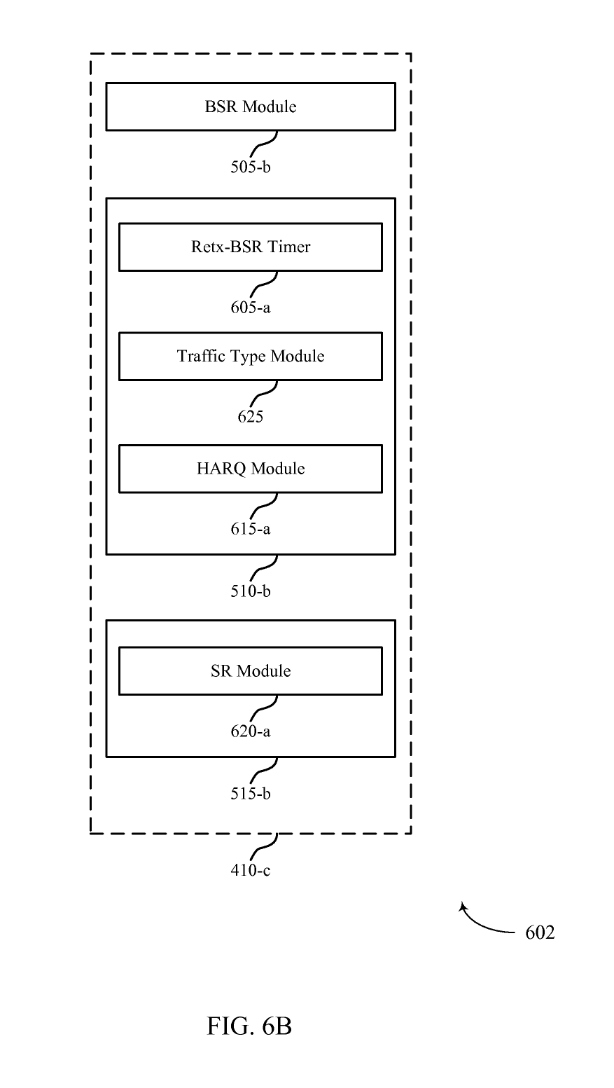

FIG. 6A shows a block diagram 601 of a scheduling module 410-b for improved uplink operation for RLC communications in accordance with the present disclosure. The scheduling module 410-b may be an example of one or more aspects of a scheduling module 410 described with reference to FIGS. 4 and/or 5. The scheduling module 410-b may include a BSR module 505-a, a BSR failure condition module 510-a, and an alternative request module 515-a. Each of these modules may perform the functions described above with reference to FIG. 5 and may be examples of the BSR module 505, the BSR failure condition module 510 and the alternative request module 515 of FIG. 5, respectively. The BSR failure condition module 510-a may also include a Retx-BSR timer 605, a duplicate PDU module 610, and/or a HARQ module 615. The alternative request module 515-a may also include an SR module 620.

The components of the scheduling module 410-b may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another Semi-Custom IC), which may be programmed in any manner known in the art. The functions of each unit may also be implemented, in whole or in part, with instructions embodied in a memory, formatted to be executed by one or more general or application-specific processors.

The Retx-BSR timer 605 may be configured such that determining that the BSR failure condition has been satisfied includes initiating a retransmission timer associated with a first time interval, e.g., the Retx-BSR timer interval in an LTE network. The Retx-BSR timer may simply define a pre-configured interval which typically ranges from 320 ms to more than 10 s. The timer may be started in connection with sending the BSR and may serve as an outer bound on the request for UL resources.

The duplicate PDU module 610 may be configured to detect a duplicate DL AM PDU prior to expiration of the first time interval. The duplicate DL AM PDU may include a repetition of data received in another DL transmission. Receiving a duplicate AM PDU may be an indication that a base station 105 is continuing to send the same data to the UE 115 based on not receiving an ACK. Thus, it may be a means of identifying a situation where early transmission of an SR may improve RLC UL operations. In some cases, the duplicate PDU module 610 may be configured to discard the duplicate DL AM PDU.

The HARQ module 615 may be configured such that determining that the BSR failure condition has been satisfied may include receiving a predetermined number of NACK indications associated with the BSR. The NACK indications may be evidence that the BSR was not successfully received by a base station 105. The predetermined number may be based on a maximum HARQ transmission parameter. For example, up to the predetermined maximum, the UE may verify that all ACK/NACK feedback received in connection with the transport block carrying the BSR are NACK indications and thereby detect the BSR failure condition before expiration of the first time interval. The HARQ module 615 may also be configured such that determining that the BSR failure condition has been satisfied may include flushing a HARQ buffer prior to receiving an ACK for the BSR. Flushing the HARQ buffer may be an indication that a threshold time period has passed without receiving and ACK for the BSR, which may be evidence that the BSR has failed.

The SR module 620 may be configured to transmit an SR after the BSR failure condition has been satisfied. In some cases, the SR module 620 may be configured to determine that the SR has failed. Thus, the SR module 620 may be configured to repeat transmission of the SR. In some cases, the SR module 620 may be configured such that the repeated transmission of the SR may be limited to a maximum rate. The SR module 620 may also be configured such that the alternative request procedure may include determining that resources have not been granted for an SR.

FIG. 6B shows a block diagram 602 of a scheduling module 410-c for improved uplink operation for RLC communications. The scheduling module 410-c may be an example of one or more aspects of a scheduling module 410 described with reference to FIGS. 4 and/or 5. The scheduling module 410-c may include a BSR module 505-b, a BSR failure condition module 510-b, and an alternative request module 515-b. Each of these modules may perform the functions described above with reference to FIG. 5 and may be examples of the BSR module 505, the BSR failure condition module 510 and the alternative request module 515 of FIG. 5, respectively. The BSR failure condition module 510-b may also include a Retx-BSR timer 605-a, a traffic type module 625, and a HARQ module 615-a. The alternative request module 515-b may also include an SR module 620-a.

The components of the scheduling module 410-b may, individually or collectively, be implemented with at least one ASIC adapted to perform some or all of the applicable functions in hardware. Alternatively, the functions may be performed by one or more other processing units (or cores), on at least one IC. In other embodiments, other types of integrated circuits may be used (e.g., Structured/Platform ASICs, an FPGA, or another Semi-Custom IC), which may be programmed in any manner known in the art. The functions of each unit may also be implemented, in whole or in part, with instructions embodied in a memory, formatted to be executed by one or more general or application-specific processors.

The Retx-BSR timer 605-a may be configured to determine that a second time interval has expired, wherein the second time interval is shorter than the first time interval. For example, a shorter time interval may be appropriate because a UE 115 has time sensitive data in a buffer that may be discarded if the UE 115 waits for the full period of the first (e.g., default) time interval. The Retx-BSR timer 605-a may be configured such that a duration of the second time interval may be based on a value of a HARQ RTT and/or on a maximum HARQ transmission parameter. The duration of the timer may thus be different for FDD and TDD systems. In one aspect, the second time interval may be determined according to Equation 1.

The traffic type module 625 may also be configured to determine that the BSR failure condition has been satisfied based on a traffic type of the data. The traffic type module 625 may be configured such that the traffic type of the data may be characterized by a QCI value which may be evaluated to determine whether the QCI value is less than a threshold. The traffic type module 625 may be configured such that the traffic type of the data may be a voice traffic type or video telecommunications traffic type. The traffic type module 625 may be configured such that the traffic type may be based on a predictable traffic pattern. An example of a predictable traffic pattern may be voice packets which have an expected transmission rate. For instance, VoLTE packets are typically transmitted once every 20 ms or 40 ms. Persons of skill in the art will recognize that other traffic types may be characterized by having predictable patterns which may be utilized by traffic type module 625 for detecting the BSR failure condition.

The HARQ module 615-a may be configured such that determining that the BSR failure condition has been satisfied may include receiving a predetermined number of NACK indications associated with the BSR. The predetermined number may be based on a maximum HARQ transmission parameter. In some examples, the HARQ module 615-a may be configured such that determining that the BSR failure condition has been satisfied may include flushing a HARQ buffer prior to receiving an ACK for the BSR. Flushing the HARQ buffer may be an indication that a threshold time period has passed without receiving and ACK for the BSR, which may be evidence that the BSR has failed.

The SR module 620-a may be configured to transmit an SR after the second time interval expires. In some examples, the SR module 620-a may also be configured to determine that the SR has failed. Thus, the SR module 620-a may be configured to repeat transmission of the SR. The repeated transmission of the SR may be limited to a maximum rate. The SR module 620-a may be configured to limit the rate to a maximum of N₁ times per second (e.g., N₁=3). The SR module 620-a may be configured such that the alternative request procedure may include determining that resources have not been granted for an SR.

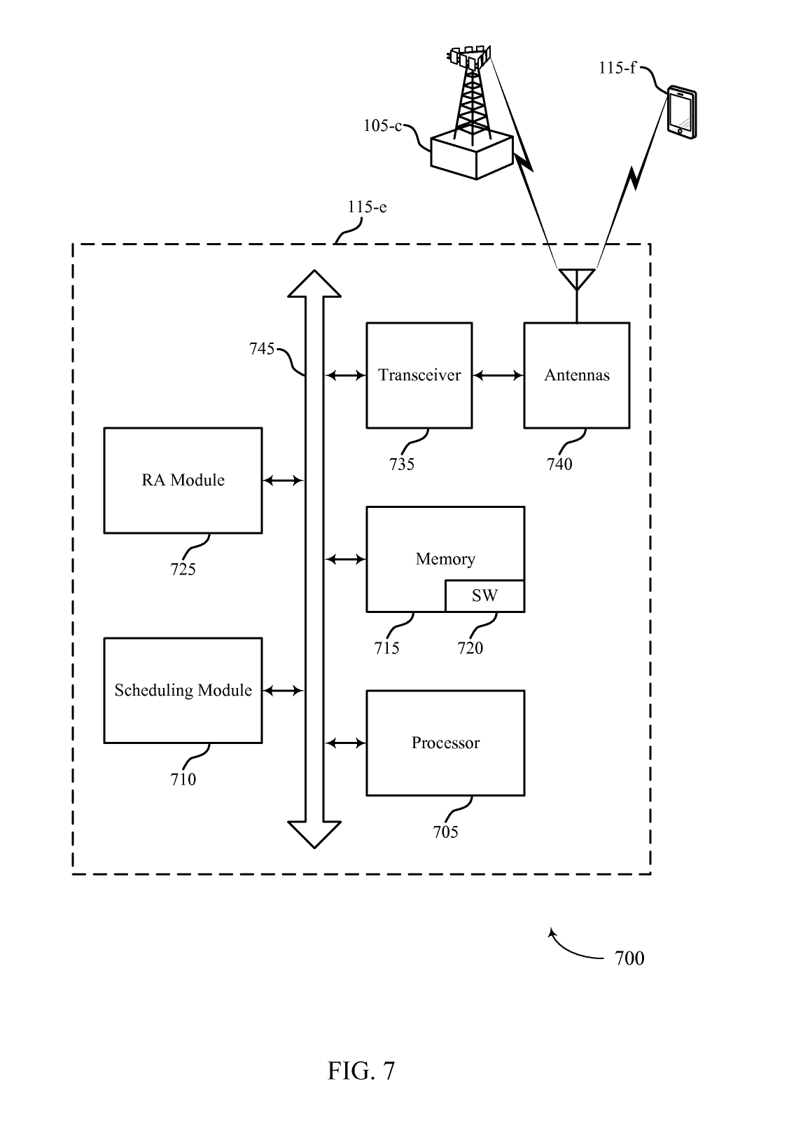

FIG. 7 shows a diagram of a system 700 for improved uplink operation for RLC communications in accordance with various embodiments. System 700 may include a UE 115-e, which may be an example of a UE 115 with reference to FIGS. 1-6. The UE 115-e may include a scheduling module 710, which may be an example of a scheduling module with reference to FIGS. 4-6. The UE 115-e may also include an random access (RA) module 725. The UE 115-d may also include components for bi-directional voice and data communications including components for transmitting communications and components for receiving communications. For example, UE 115-e may be in communication with a base station 105-c and/or another UE 115-f.

The RA module 725 may also be configured to initiate a random access procedure. In some examples, a random access procedure is initiated as an alternative request procedure if UE 115-e determines that its connection with a base station is compromised. For example, on failing to get a grant after a predetermined number (e.g., N₂) of transmissions of SR, a UE 115-e may trigger a random access procedure to get back in sync with the network.

The cause for the random access procedure may be given as “UL-Data arrival”. N₂ may be set based on a packet data convergence protocol (PDCP) discard timer value and may be selected such that it is much less than the SR resource release counter N₂.

The UE 115-e may also include a processor module 705, and memory 715 (including software (SW) 720), a transceiver module 735, and one or more antenna(s) 740, which each may communicate, directly or indirectly, with each other (e.g., via one or more buses 745. The transceiver module 735 may be configured to communicate bi-directionally, via the antenna(s) 740 and/or one or more wired or wireless links, with one or more networks, as described above. For example, the transceiver module 735 may be configured to communicate bi-directionally with a base station 105-c. The transceiver module 735 may include a modem configured to modulate the packets and provide the modulated packets to the antenna(s) 740 for transmission, and to demodulate packets received from the antenna(s) 740. While the UE 115-e may include a single antenna 740, the UE 115-e may also have multiple antennas 740 capable of concurrently transmitting and/or receiving multiple wireless transmissions. The transceiver module 735 may also be capable of concurrently communicating with one or more base stations 105-c.

The memory 715 may include random access memory (RAM) and read only memory (ROM). The memory 715 may store computer-readable, computer-executable software/firmware code 720 containing instructions that are configured to, when executed, cause the processor module 705 to perform various functions described herein (e.g., call processing, database management, processing of carrier mode indicators, reporting channel state information (CSI), etc.). Alternatively, the software/firmware code 720 may not be directly executable by the processor module 705 but be configured to cause a computer (e.g., when compiled and executed) to perform functions described herein. The processor module 705 may include an intelligent hardware device, e.g., a cyclic prefix (CP), a microcontroller, an ASIC, etc. may include RAM and ROM. The memory 715 may store computer-readable, computer-executable software/firmware code 720 containing instructions that are configured to, when executed, cause the processor module 705 to perform various functions described herein (e.g., call processing, database management, processing of carrier mode indicators, reporting CSI, etc.). Alternatively, the software/firmware code 720 may not be directly executable by the processor module 705 but be configured to cause a computer (e.g., when compiled and executed) to perform functions described herein. The processor module 705 may include an intelligent hardware device, e.g., a central processing unit (CPU), a microcontroller, an ASIC, etc.

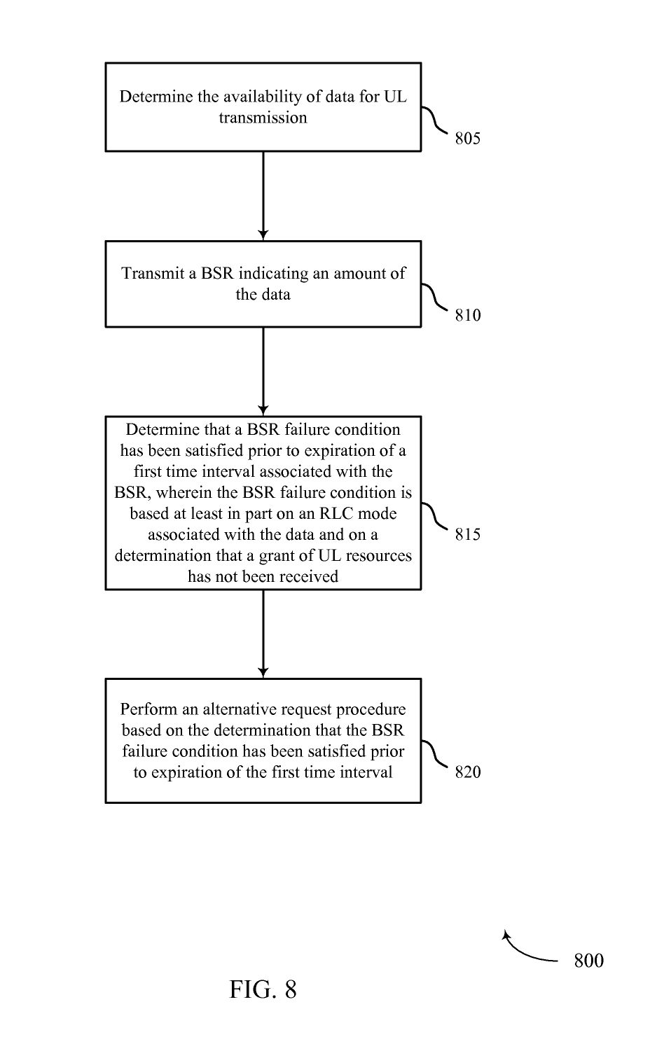

FIG. 8 shows a flowchart 800 illustrating a method for improved uplink operation for RLC communications in accordance with various embodiments. The functions of flowchart 800 may be implemented by a UE 115 or its components as described with reference to FIGS. 1-7. In certain examples, the blocks of the flowchart 800 may be performed by the scheduling module with reference to FIGS. 4-7.

At block 805, the UE 115 may determine the availability of data for UL transmission. The data may be associated with an RLC mode, e.g., RLC AM or RLC UM. In certain examples, the functions of block 805 may be performed by the BSR module 505 as described above with reference to FIG. 5. At block 810, the UE 115 may transmit a BSR indicating an amount of the data. In certain examples, the functions of block 810 may be performed by the BSR module 505 as described above with reference to FIG. 5.

At block 815, the UE 115 may determine that a BSR failure condition has been satisfied prior to expiration of a first time interval associated with the BSR, wherein the BSR failure condition is based at least in part on an RLC mode associated with the data and on a determination that a grant of UL resources has not been received. In some examples, determining that the BSR failure condition has been satisfied may include initiating a retransmission timer associated with a first time interval and receiving a duplicate DL AM

PDU prior to expiration of the first time interval. In some examples, determining that the BSR failure condition has been satisfied may include determining that a second time interval has expired based on the retransmission timer, wherein the second time interval is shorter than the first time interval.

In some examples, determining that the BSR failure condition has been satisfied may include receiving a predetermined number of NACK indications associated with the BSR. In other examples, determining that the BSR failure condition has been satisfied may include flushing a HARQ buffer prior to receiving an ACK for the BSR. In some examples, determining that the BSR failure condition has been satisfied may include determining that the UE tuned away from a network cell prior to receiving an ACK for the BSR. In certain examples, the functions of block 815 may be performed by the BSR failure condition module 510 as described above with reference to FIG. 5.

At block 820, the UE 115 may perform an alternative procedure based on the determination that the BSR failure condition has been satisfied prior to expiration of the first time interval. For example, the UE 115 may transmit at least one SR. In another example, the UE 115 may initiate a random access procedure. In certain examples, the functions of block 820 may be performed by the alternative request module 515 as described above with reference to FIG. 5.

It should be noted that the method of flowchart 800 is just one implementation and that the operations of the method, and the steps may be rearranged or otherwise modified such that other implementations are possible.

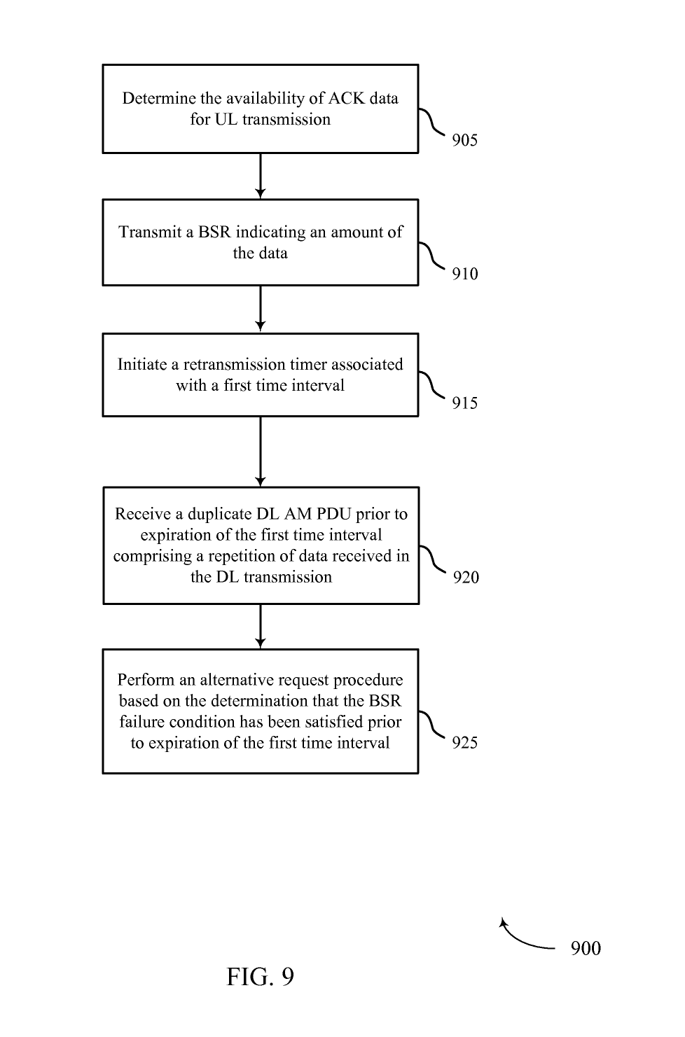

FIG. 9 shows a flowchart 900 illustrating a method for improved uplink operation for RLC communications in accordance with various embodiments. The functions of flowchart 900 may be implemented by a UE 115 or its components as described with reference to FIGS. 1-7. In certain examples, the blocks of the flowchart 900 may be performed by the scheduling module described with reference to FIGS. 4-7. The method described in flowchart 900 may also incorporate aspects of flowchart 800 of FIG. 8.

At block 905, the UE 115 may determine the availability of ACK data for UL transmission. In certain examples, the functions of block 905 may be performed by the BSR module 505 as described above with reference to FIG. 5. At block 910, the UE 115 may transmit a BSR indicating an amount of the data. In certain examples, the functions of block 910 may also be performed by the BSR module 505 as described above with reference to FIG. 5.

At block 915, the UE 115 may initiate a retransmission timer associated with the first time interval. In certain examples, the functions of block 925 may be performed by the Retx-BSR timer 605 as described above with reference to FIG. 6.

At block 920, the UE 115 may receive a duplicate DL AM PDU prior to expiration of the first time interval comprising a repetition of data received in the DL transmission. Based on the retransmission timer and the duplicate DL AM PDU, the UE 115 may determine that the BSR has failed. In certain examples, the functions of block 930 may be performed by the duplicate PDU module 610 as described above with reference to FIG. 6.

At block 925, the UE 115 may perform an alternative request procedure based on the determination that the BSR failure condition has been satisfied prior to expiration of the first time interval. For example, the UE 115 may transmit at least one SR. In another example, the UE 115 may initiate a random access procedure. In certain examples, the functions of block 820 may be performed by the alternative request module 515 as described above with reference to FIG. 5.

It should be noted that the method of flowchart 900 is just one implementation and that the operations of the method, and the steps may be rearranged or otherwise modified such that other implementations are possible.

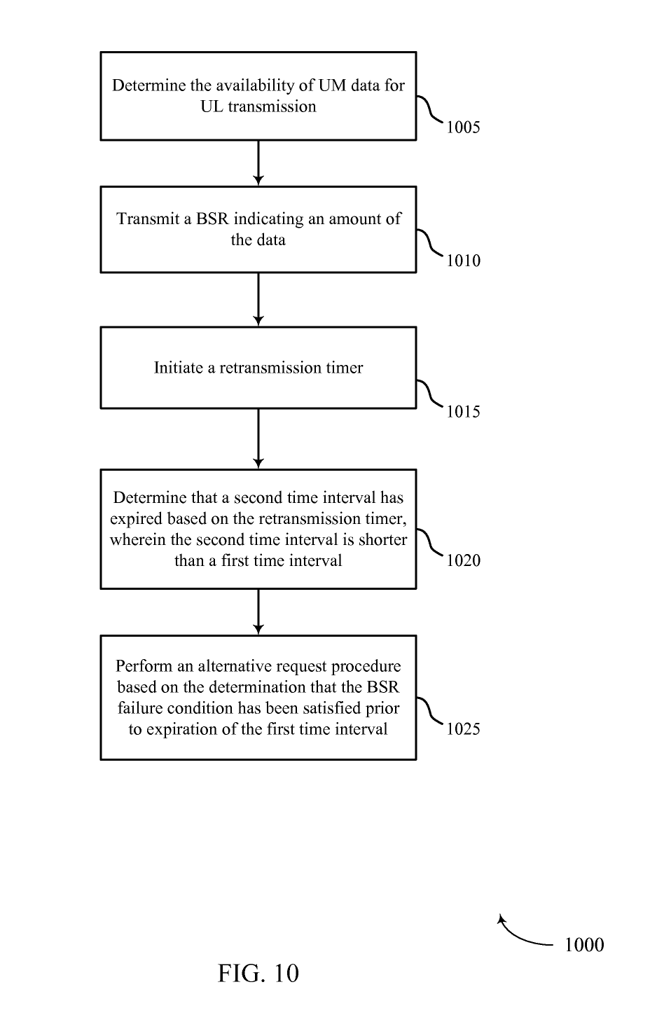

FIG. 10 shows a flowchart 1000 illustrating a method for improved uplink operation for RLC communications in accordance with various embodiments. The functions of flowchart 1000 may be implemented by a UE 115 or its components as described with reference to FIGS. 1-7. In certain examples, the blocks of the flowchart 1000 may be performed by the scheduling module with reference to FIGS. 4-7. The method described in flowchart 1000 may also incorporate aspects of flowchart 800 of FIG. 8.

At block 1005, the UE 115 may determine the availability of UM data for UL transmission. In certain examples, the functions of block 1005 may be performed by the BSR module 505 as described above with reference to FIG. 5. At block 1010, the UE 115 may transmit a BSR indicating an amount of the data. In certain examples, the functions of block 1010 may be performed by the BSR module 505 as described above with reference to FIG. 5.

At block 1015, the UE 115 may initiate a retransmission timer based on a first time interval. In certain examples, the functions of block 1025 may be performed by the Retx-BSR timer 605 as described above with reference to FIGS. 6A, and 6B. At block 1020, the UE 115 may determine that a second time interval has expired based on the retransmission timer, wherein the second time interval is shorter than the first time interval. In some examples, a retransmission timer is reset from the first time interval to the second time interval. In other examples, an additional timer may be used to determine when the second time interval has expired. In certain examples, the functions of block 1030 may be performed by the Retx-BSR timer 605 as described above with reference to FIG. 6.

At block 1025, the UE 115 may perform an alternative request procedure based on the determination that the BSR failure condition has been satisfied prior to expiration of the first time interval. In certain examples, the functions of block 1020 may be performed by the alternative request module 515 as described above with reference to FIG. 5.

It should be noted that the method of flowchart 1000 is just one implementation and that the operations of the method, and the steps may be rearranged or otherwise modified such that other implementations are possible.

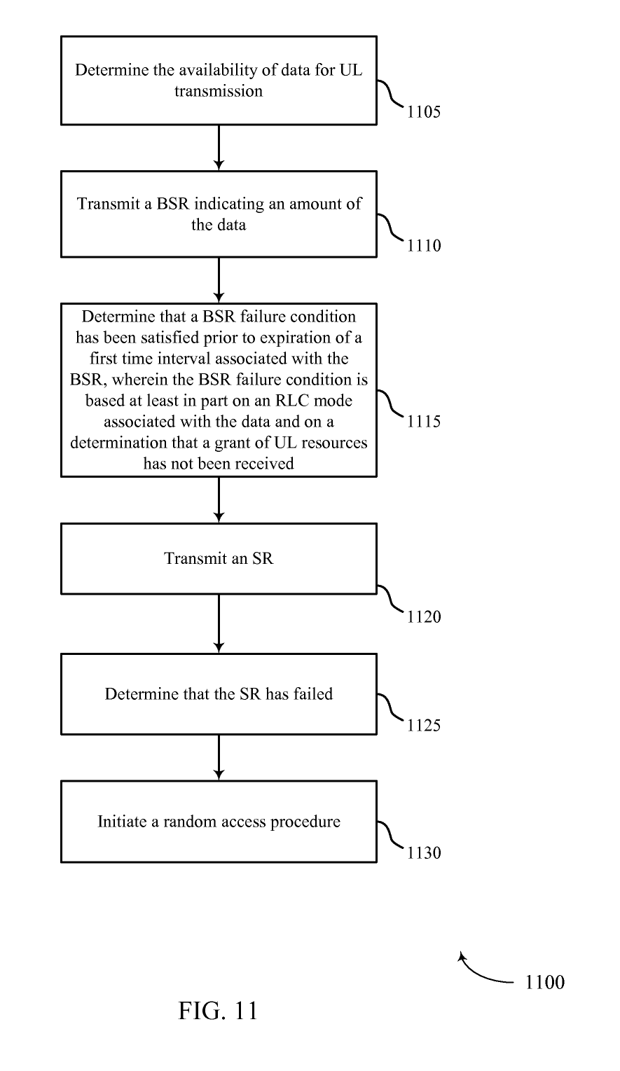

FIG. 11 shows a flowchart 1100 illustrating a method for improved uplink operation for RLC communications in accordance with various embodiments. The functions of flowchart 1100 may be implemented by a UE 115 or its components as described with reference to FIGS. 1-7. In certain examples, the blocks of the flowchart 1100 may be performed by the scheduling module with reference to FIGS. 4-7. The method described in flowchart 1100 may also incorporate aspects of flowcharts 800 to 1000 of FIGS. 8-10.

At block 1105, the UE 115 may determine the availability of data for UL transmission. In certain examples, the functions of block 1105 may be performed by the BSR module 505 as described above with reference to FIG. 5. At block 1110, the UE 115 may transmit a BSR indicating an amount of the data. In certain examples, the functions of block 1110 may be performed by the BSR module 505 as described above with reference to FIG. 5.

At block 1115, the UE 115 may determine that a BSR failure condition has been satisfied prior to expiration of a first time interval associated with the BSR, wherein the BSR failure condition is based at least in part on an RLC mode associated with the data and on a determination that a grant of UL resources has not been received. In certain examples, the functions of block 1115 may be performed by the BSR failure condition module 510 as described above with reference to FIG. 5.

At block 1120, the UE 115 may transmit an SR based on the determination that the BSR failure condition has been satisfied prior to expiration of the first time interval. In certain examples, the functions of block 1120 may be performed by the alternative request module 515 as described above with reference to FIG. 5. At block 1125, the UE 115 may determine that the SR has failed. In certain examples, the functions of block 1125 may be performed by the SR module 620 as described above with reference to FIG. 6.

At block 1130, the UE 115 may initiate a random access procedure. In certain examples, the functions of block 1130 may be performed by the RA module 725 as described above with reference to FIG. 6.

It should be noted that the method of flowchart 1100 is just one implementation and that the operations of the method, and the steps may be rearranged or otherwise modified such that other implementations are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a digital signal processor (DSP) and a microprocessor, multiple microprocessors, one or more microprocessors in conjunction with a DSP core, or any other such configuration.

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “ or ” as used in a list of items (for example, a list of items prefaced by a phrase such as “at least one of” or “one or more of”) indicates a disjunctive list such that, for example, a list of [at least one of A, B, or C] means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable storage media can comprise random access memory (RAM), read only memory (ROM), electrically erasable programmable read only memory (EEPROM), compact disk (CD) ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or digital subscriber line (DSL), are included in the definition of computer-readable medium. Disk and disc, as used herein, include compact disk (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

Techniques described herein may be used for various wireless communications systems such as code division multiple access (CDMA), time division multiple access (TDMA), frequency division multiple access (FDMA), orthogonal frequency division multiple access (OFDMA), single carrier frequency division multiple access (SC-FDMA), and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and Long Term Evolution (LTE)-Advanced (LTE-A) are new releases of Universal Mobile Telecommunications System (UMTS) that use E-UTRA. UTRA, E-UTRA, Universal Mobile Telecommunications System (UMTS), LTE, LTE-A, and Global System for Mobile communications (GSM) are described in documents from an organization named “3rd Generation Partnership Project” (3GPP). CDMA2000 and unacknowledged mode (UM)B are described in documents from an organization named “3rd Generation Partnership Project 2” (3GPP2). The techniques described herein may be used for the systems and radio technologies mentioned above as well as other systems and radio technologies. The description above, however, describes an LTE system for purposes of example, and LTE terminology is used in much of the description above, although the techniques are applicable beyond LTE applications.

What is claimed is:

1. A method of wireless communication, comprising:
determining the availability of data for uplink (UL) transmission;
transmitting a buffer status report (BSR) indicating an amount of the data;
determining that a BSR failure condition has been satisfied prior to expiration of a first time interval associated with the BSR, wherein the BSR failure condition is based at least in part on a radio link control (RLC) mode associated with the data and on a determination that a grant of UL resources has not been received; and
performing an alternative request procedure based on the determination that the BSR failure condition has been satisfied prior to expiration of the first time interval.

2. The method of claim 1, wherein the data comprises an acknowledgement (ACK) for a corresponding downlink (DL) transmission in an RLC acknowledged mode (AM).

3. The method of claim 2, wherein determining that the BSR failure condition has been satisfied comprises:
initiating a retransmission timer associated with the first time interval; and
receiving a duplicate DL AM protocol data unit (PDU) prior to expiration of the retransmission timer comprising a repetition of data received in the DL transmission.

4. The method of claim 3, further comprising:
discarding the duplicate DL AM PDU.

5. The method of claim 1, wherein the RLC mode associated with the data is an unacknowledged mode (UM).

6. The method of claim 5, wherein determining that the BSR failure condition has been satisfied comprises:
initiating a retransmission timer;
determining that a second time interval has expired based on the retransmission timer, wherein the second time interval is shorter than the first time interval;
receiving the grant of UL resources based on the alternative request procedure; and
transmitting the data.

7. The method of claim 6, wherein a duration of the second time interval is based on a value of a hybrid automatic repeat request (HARQ) round trip time (RTT) [associated with a carrier on which the BSR is transmitted?].

8. The method of claim 7, wherein the duration of the second time interval is based on a maximum HARQ transmission parameter.

9. The method of claim 6, further comprising:
transmitting an SR in response to expiration of the second interval.

10. The method of claim 5, wherein
determining that the BSR failure condition has been satisfied is based a traffic type of the data.

11. The method of claim 10, wherein the traffic type of the data is characterized by a quality of service (QoS) class identifier (QCI) value less than a threshold.

12. The method of claim 10, wherein the traffic type of the data is a voice traffic type or video telecommunications traffic type.

13. The method of claim 10, wherein the traffic type is based on a predictable traffic pattern.

14. The method of claim 1, wherein determining that the BSR failure condition has been satisfied comprises:
receiving a predetermined number of negative acknowledgement (NACK) indications associated with the BSR.

15. The method of claim 14, wherein the predetermined number is based on a maximum HARQ transmission parameter.

16. The method of claim 1, wherein determining that the BSR failure condition has been satisfied comprises:
flushing a HARQ buffer prior to receiving an ACK for the BSR.

17. The method of claim 1, wherein determining that the BSR failure condition has been satisfied comprises:
determining that the UE tuned away from a network cell prior to receiving an ACK for the BSR.

18. The method of claim 1, wherein the alternative request procedure comprises:
transmitting an SR.

19. The method of claim 18, further comprising:
determining that the SR has failed; and
initiating a random access procedure.

20. The method of claim 18, further comprising:
repeating transmission of the SR.

21. The method of claim 20, wherein the repeated transmission of the SR is limited to a maximum rate.

22. The method of claim 18, wherein the alternative request procedure comprises:
determining that resources have not been granted in response to the SR; and
initiating a random access procedure.

23. The method of claim 1, wherein the determination that a grant of UL resources has not been received comprises a determination that UL resources have not been granted for at least a portion of the data.

24. The method of claim 1, wherein the first time interval is a based on a Retx-BSR timer value configured for the UE.

25. An apparatus for wireless communication, comprising:
means for determining the availability of data for UL transmission;
means for transmitting a BSR indicating an amount of the data;
means for determining that a BSR failure condition has been satisfied prior to expiration of a first time interval associated with the BSR, wherein the BSR failure condition is based at least in part on an RLC mode associated with the data and on a determination that a grant of UL resources has not been received; and
means for performing an alternative request procedure based on the determination that the BSR failure condition has been satisfied prior to expiration of the first time interval.

26. The apparatus of claim 25, wherein the data comprises an ACK for a corresponding DL transmission in an RLC AM.

27. The apparatus of claim 26, wherein determining that the BSR failure condition has been satisfied comprises:
initiating a retransmission timer associated with the first time interval; and
means for receiving a duplicate DL AM PDU prior to expiration of the first time interval comprising a repetition of data received in the DL transmission.

28. The apparatus of claim 27, further comprising:
means for discarding the duplicate DL AM PDU.

29. The apparatus of claim 25, wherein the RLC mode associated with the data is a UM.

30. The apparatus of claim 29, wherein determining that the BSR failure condition has been satisfied comprises:
initiating a retransmission timer;
means for determining that a second time interval has expired based on the retransmission timer, wherein the second time interval is shorter than the first time interval;
means for receiving the grant of UL resources based on the alternative request procedure; and
means for transmitting the data.

31. The apparatus of claim 30, wherein a duration of the second time interval is based on a value of a HARQ RTT.

32. The apparatus of claim 31, wherein the duration of the second time interval is based on a maximum HARQ transmission parameter.

33. The apparatus of claim 30, further comprising:
means for transmitting an SR after the second time interval expires.

34. The apparatus of claim 29, further comprising:
means for determining that the BSR failure condition has been satisfied is based a traffic type of the data.

35. The apparatus of claim 34, wherein the traffic type of the data is characterized by a QCI value less than a threshold.

36. The apparatus of claim 34, wherein the traffic type of the data is a voice traffic type or video telecommunications traffic type.

37. The apparatus of claim 34, wherein the traffic type is based on a predictable traffic pattern.

38. The apparatus of claim 25, wherein determining that the BSR failure condition has been satisfied comprises:
receiving a predetermined number of NACK indications associated with the BSR.

39. The apparatus of claim 38, wherein the predetermined number is based on a maximum HARQ transmission parameter.

40. The apparatus of claim 25, wherein determining that the BSR failure condition has been satisfied comprises:
flushing a HARQ buffer prior to receiving an ACK for the BSR.

41. The apparatus of claim 25, wherein determining that the BSR failure condition has been satisfied comprises:
determining that the UE tuned away from a network cell prior to receiving an ACK for the BSR.

42. The apparatus of claim 25, wherein the alternative request procedure comprises:
transmitting an SR.

43. The apparatus of claim 42, further comprising:
means for determining that the SR has failed; and
means for initiating a random access procedure.

44. The apparatus of claim 42, further comprising:
means for repeating transmission of the SR.

45. The apparatus of claim 44, wherein the repeated transmission of the SR is limited to a maximum rate.

46. The apparatus of claim 25, wherein the alternative request procedure comprises:
determining that resources have not been granted for an SR; and
means for initiating a random access procedure.

47. The apparatus of claim 25, wherein the determination that a grant of UL resources has not been received comprises a determination that UL resources have not been granted for at least a portion of the data.

48. The apparatus of claim 25, wherein the first time interval is a based on a Retx-BSR timer.

49. An apparatus for wireless communication, comprising a processor, memory in electronic communication with the processor and instructions stored in the memory, the instructions being executable by the processor to:
determine the availability of data for UL transmission;
transmit a BSR indicating an amount of the data;
determine that a BSR failure condition has been satisfied prior to expiration of a first time interval associated with the BSR, wherein the BSR failure condition is based at least in part on an RLC mode associated with the data and on a determination that a grant of UL resources has not been received; and
perform an alternative request procedure based on the determination that the BSR failure condition has been satisfied prior to expiration of the first time interval.

50. The apparatus of claim 49, wherein the data comprises an ACK for a corresponding DL transmission in an RLC AM.

51. The apparatus of claim 50, wherein determining that the BSR failure condition has been satisfied comprises:
initiating a retransmission timer associated with the first time interval; and
receive a duplicate DL AM PDU prior to expiration of the first time interval comprising a repetition of data received in the DL transmission.

52. The apparatus of claim 51, the instructions being further executable by the processor to:
discard the duplicate DL AM PDU.

53. The apparatus of claim 49, wherein the RLC mode associated with the data is a UM.

54. The apparatus of claim 53, wherein determining that the BSR failure condition has been satisfied comprises:
initiating a retransmission timer;
determine that a second time interval has expired based on the retransmission timer, wherein the second time interval is shorter than the first time interval;
receive the grant of UL resources based on the alternative request procedure; and
transmit the data.

55. The apparatus of claim 54, wherein a duration of the second time interval is based on a value of a HARQ RTT.

56. The apparatus of claim 55, wherein the duration of the second time interval is based on a maximum HARQ transmission parameter.

57. The apparatus of claim 54, the instructions being further executable by the processor to:
transmit an SR after the second time interval expires.

58. The apparatus of claim 53, the instructions being further executable by the processor to:
determine that the BSR failure condition has been satisfied is based a traffic type of the data.

59. The apparatus of claim 49, wherein the alternative request procedure comprises:
transmitting an SR.

60. A computer program product for wireless communication, the computer program product comprising a non-transitory computer-readable medium storing instructions executable by a processor to:
determine the availability of data for UL transmission;
transmit a BSR indicating an amount of the data;
determine that a BSR failure condition has been satisfied prior to expiration of a first time interval associated with the BSR, wherein the BSR failure condition is based at least in part on an RLC mode associated with the data and on a determination that a grant of UL resources has not been received; and
perform an alternative request procedure based on the determination that the BSR failure condition has been satisfied prior to expiration of the first time interval.

61. The computer program product of claim 60, wherein the data comprises an ACK for a corresponding DL transmission in an RLC AM.

62. The computer program product of claim 61, wherein determining that the BSR failure condition has been satisfied comprises:
initiating a retransmission timer associated with the first time interval; and
receive a duplicate DL AM PDU prior to expiration of the first time interval comprising a repetition of data received in the DL transmission.

63. The computer program product of claim 62, the instructions being further executable by the processor to:
discard the duplicate DL AM PDU.

64. The computer program product of claim 60, wherein the RLC mode associated with the data is a UM.

65. The computer program product of claim 64, wherein determining that the BSR failure condition has been satisfied comprises:
initiating a retransmission timer;
determine that a second time interval has expired based on the retransmission timer, wherein the second time interval is shorter than the first time interval;
receive the grant of UL resources based on the alternative request procedure; and
transmit the data.

66. The computer program product of claim 65, the instructions being further executable by the processor to:
transmit an SR after the second time interval expires.

67. The computer program product of claim 64, the instructions being further executable by the processor to:
determine that the BSR failure condition has been satisfied is based a traffic type of the data.

68. The computer program product of claim 60, wherein determining that the BSR failure condition has been satisfied comprises:
receiving a predetermined number of NACK indications associated with the BSR.

69. The computer program product of claim 60, wherein the alternative request procedure comprises:
transmitting an SR.

70. The computer program product of claim 69, the instructions being further executable by the processor to:
determine that the SR has failed; and
initiate a random access procedure.

71. The computer program product of claim 69, the instructions being further executable by the processor to:
repeat transmission of the SR.

72. The computer program product of claim 71, wherein the repeated transmission of the SR is limited to a maximum rate.

73. The computer program product of claim 60, wherein the alternative request procedure comprises:
determining that resources have not been granted for an SR; and
initiate a random access procedure.

74. The computer program product of claim 60, wherein the determination that a grant of UL resources has not been received comprises a determination that UL resources have not been granted for at least a portion of the data.

75. The computer program product of claim 60, wherein the first time interval is a based on a Retx-BSR timer.
